(19) United States
(12) Patent Application Publication
(10) Pub. No.: US 2022/0132824 A1
(43) Pub. Date: May 5, 2022

(54) INSECT CAPTURE DEVICE

(71) Applicant: 19 Thrasio Nineteen, Inc., Walpole, MA (US)

(72) Inventor: David Paul TOLEDO, Salt Lake City, UT (US)

(73) Assignee: 19 Thrasio Nineteen, Inc., Walpole, MA (US)

(21) Appl. No.: 17/512,922

(22) Filed: Oct. 28, 2021

Related U.S. Application Data
(60) Provisional application No. 63/108,256, filed on Oct. 30, 2020.

(51) Int. Cl. A01M 1/14

(52) U.S. Cl. CPC A01M 1/145

(57) ABSTRACT

An insect capture device is provided. The insect capture device has a housing having a cover with a plurality of openings through which insects enter the housing. A light assembly is mounted to the housing and adapted to attract the insects. A bait container is mounted on the housing to hold insect bait. A fan is disposed within the housing oriented to pull insects through the cover and into the housing. A removable tray cooperates with the housing. The tray configured to hold an adhesive pad for capturing insects that entered the housing.

### CROSS-REFERENCE TO RELATED APPLICATIONS

This application claims the benefit of U.S. provisional application Ser. No. 63/108,256 filed Oct. 30, 2020 the disclosure of which is hereby incorporated in its entirety by reference herein.

### TECHNICAL FIELD

The application relates generally to devices for attracting mosquitos, flies and other flying insects for capture and subsequent disposal.

### SUMMARY

In one embodiment, an insect capture device is provided. The insect capture device has a housing having a cover with a plurality of openings through which insects enter the housing. A light assembly is mounted to the housing and adapted to attract the insects. A bait container is mounted on the housing to hold insect bait. A fan is disposed within the housing oriented to pull insects through the cover and into the housing. A removable tray cooperates with the housing. The tray configured to hold an adhesive pad for capturing insects that entered the housing.

In another embodiment, the light assembly has a plurality of ultraviolet light-emitting diodes (UV LEDs).

In another embodiment, the light assembly extends above the housing.

In another embodiment, the light assembly is spaced apart above the housing.

In another embodiment, the light assembly has a toroidal-shaped enclosure.

In another embodiment, a funnel is disposed within the housing to direct the insects toward the adhesive pad.

In another embodiment, the funnel is disposed below the fan, the funnel having an inlet opening adjacent the fan, and an outlet opening adjacent the adhesive pad, wherein the outlet opening is smaller than the inlet opening.

In another embodiment, a controller is in communication with the fan and the light assembly, the controller programmed to provide a signal to the fan and light assembly to vary at least one of a brightness of the light assembly or a speed of the fan.

In another embodiment, an ambient light sensor is provided in communication with the controller. The controller is programmed to receive an ambient light input from the ambient light sensor. A signal is provided to automatically vary at least one of the brightness of the light assembly or the speed of the fan based on the ambient light input.

In another embodiment, if the ambient light input decreases, the controller automatically increases at least one of the brightness of the light assembly or the speed of the fan.

In another embodiment, a control panel is provided in communication with the controller. The controller is programmed to receive an input from a user. A signal is provided to vary at least one of the brightness of the light assembly or the speed of the fan based on the input of the user.

In another embodiment, the tray is seated within a slot formed in a lower portion of the housing.

In another embodiment, the tray has a recessed area to hold the adhesive pad.

In another embodiment, the bait container is mounted to the cover outside the housing and has a plurality of apertures formed in a top portion to allow a scent to emanate therefrom to attract insects.

In at least one embodiment, an insect capture device is provided with a cylindrical housing having a cover with a plurality of openings through which insects enter the housing. A light ring assembly has at least one ultra-violet LED (UV LED) adapted to attract insects. The light ring is mounted to the housing at a spaced apart location from the cover. A bait container is mounted to the cover outside the housing to hold insect bait. A fan is disposed within the housing oriented to pull insects through the cover and into the housing. A removable tray cooperates with the housing. The tray is configured to hold an adhesive pad for capturing insects that entered the housing. A conical funnel positioned between the fan and the tray to direct the insect towards the adhesive pad.

In another embodiment, the light ring assembly has a toroidal-shaped enclosure.

In another embodiment, the funnel has an inlet opening adjacent the fan, and an outlet opening adjacent the adhesive pad, wherein the outlet opening is smaller than the inlet opening.

In at least one embodiment, an insect capture device is provided with a housing having a cover with a plurality of openings through which insects enter the housing. A light assembly is mounted to the housing and adapted to attract the insects. A fan disposed is within the housing and is oriented to pull insects through the cover and into the housing. A removable tray cooperates with the housing configured to hold a replaceable adhesive pad for capturing insects that entered the housing. A controller is in communication with the fan and the light assembly. The controller is programmed to provide a signal to the fan and light assembly to vary at least one of a brightness of the light assembly or a speed of the fan.

### BRIEF DESCRIPTION OF THE DRAWINGS

FIG. 1 shows a perspective view of an insect capture device according to an embodiment.

FIG. 2 shows a front view of the insect capture device of FIG. 1.

FIG. 3 shows a rear view of the insect capture device of FIG. 1.

FIG. 4 shows an exploded view of the insect capture device according to an embodiment.

FIG. 5A shows a light assembly of the insect capture device.

FIG. 5B shows the exemplary light assembly of FIG. 5A, wherein the top portion has been removed from the bottom portion to expose an internal compartment containing a plurality of LEDs.

FIG. 6 shows an exemplary bait container that may be removably secured to an insect capture device.

FIG. 7 shows an exemplary top portion of the bait container.

FIGS. 8A-8B show various views of an exemplary bottom portion of the bait container.

FIG. 9 shows an exemplary bait container according to another embodiment.

FIG. 10 shows an exemplary housing cover.

FIG. 11 shows alternative housing cover embodiments wherein each includes a plurality of openings extending through a top surface thereof.

FIG. 12A shows a perspective view of an upper portion of a housing according to an embodiment.

FIG. 12B shows an exploded view with a top view of the housing upper portion and a fan that may be disposed within an interior space of the upper portion.

FIG. 12C shows a top view of the housing upper portion with fan rotatably attached within the interior space of the upper portion.

FIG. 13 shows a lower portion and a base of a housing according to an embodiment.

FIG. 14 shows the insect capture device with a tray that may be removably inserted.

FIGS. 15A-15C show alternative embodiments of the housing lower portion and housing base.

FIG. 16A shows a housing lower portion and a funnel that may be disposed within an interior space of the lower portion.

FIG. 16B shows a funnel seated within an interior space of a housing lower portion.

FIG. 17 shows an exemplary housing lower portion having a plurality of apertures.

FIG. 18 shows an exemplary insect control device with a housing that is transparent so the assembled inner components are visible.

FIG. 19A shows a top-front perspective view of an insect capture device according to an embodiment.

FIG. 19B shows a bottom-rear perspective view of the insect capture device of FIG. 19A.

FIG. 19C shows a front view of the insect capture device of FIG. 19A.

FIG. 19D shows rear view of the insect capture device of FIG. 19A.

FIG. 19E shows a left-side view of the insect capture device of FIG. 19A.

FIG. 19F shows a right-side view of the insect capture device of FIG. 19A.

FIG. 19G shows a top view of the insect capture device of FIG. 19A.

FIG. 19H shows a bottom view of the insect capture device of FIG. 19A.

The details of one or more embodiments of the subject matter of this specification are set forth in the accompanying drawings and the description below.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

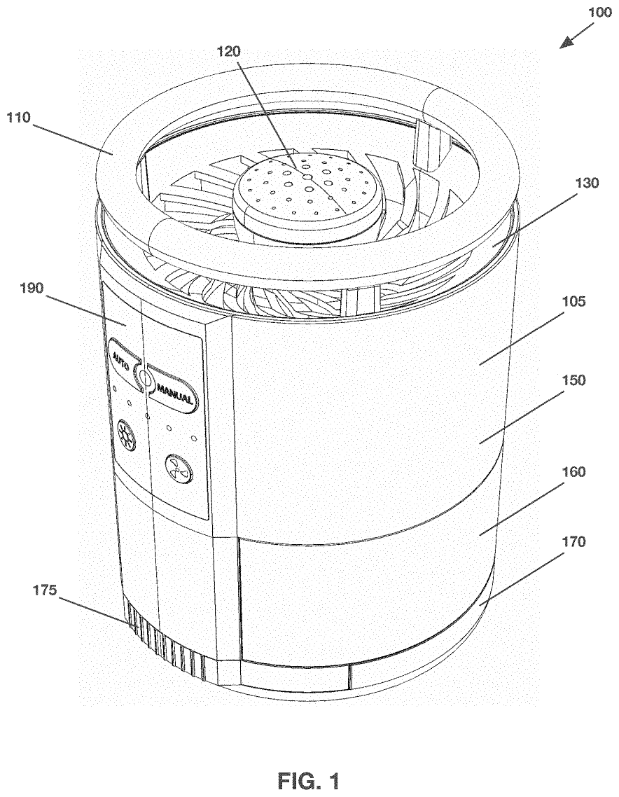

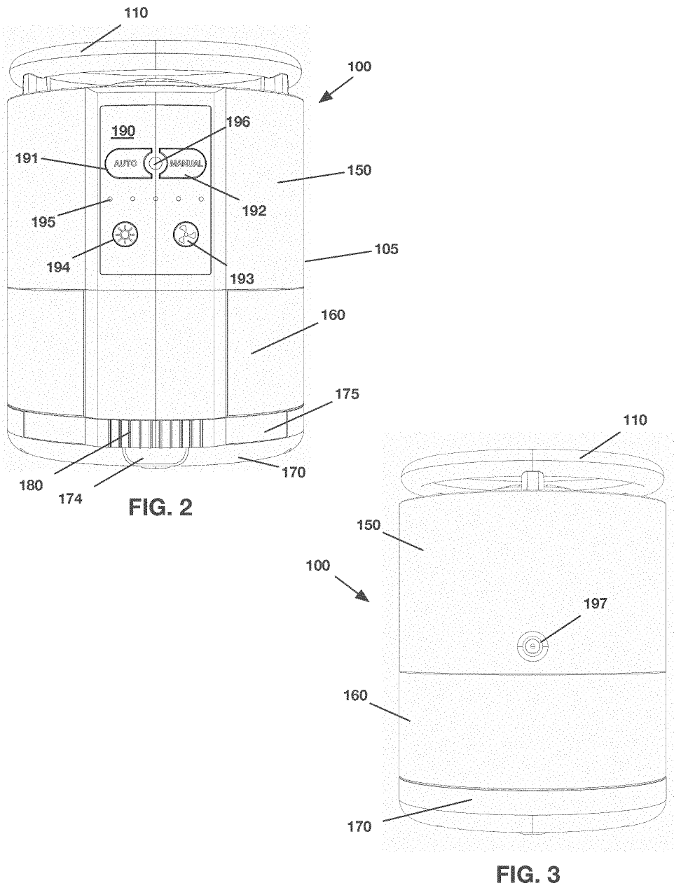

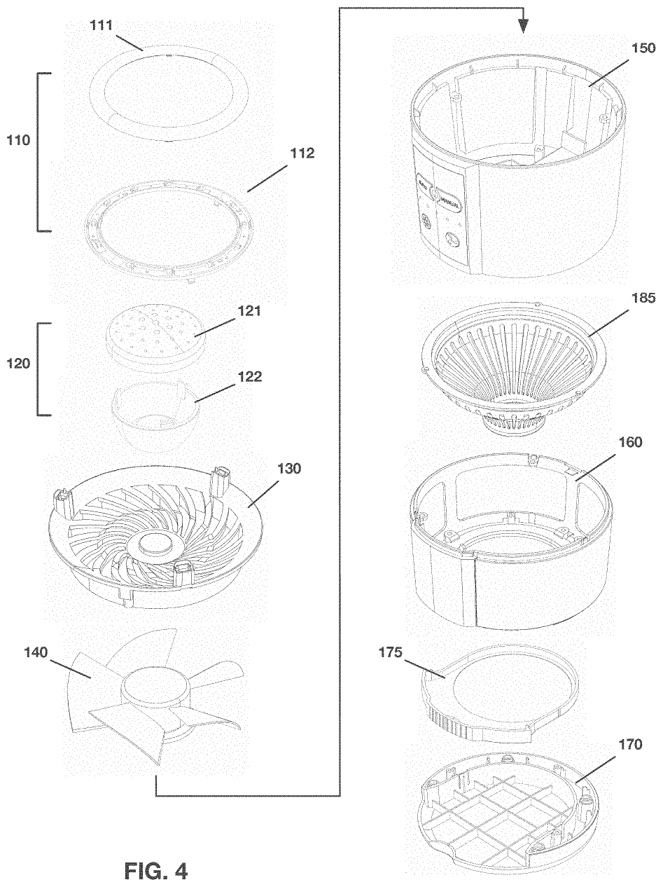

As shown in FIGS. 1-4, an insect control device 100 is provided. Various insect capture devices are described herein to attract insects for capture and subsequent disposal. Generally, the insect capture device 100 may have a bait-holding container 120 adapted to hold a substance that attracts insects within an interior compartment thereof 123 and to capture insects within the interior compartment. The insect capture device 100 has a housing cover 130 with a plurality of openings 133 through which an insect may travel to access an interior space of the housing. A fan 140 is disposed within an interior space 153 of an upper portion 150 of the housing 105. The fan is adapted to pull insects through the cover and into the housing. A funnel 185 is disposed within an interior space 163 of a lower portion 160 of the housing 105, below the fan 140. The funnel 185 is configured to direct insects towards an adhesive pad 182. A removable tray 175 is seated within a slot 106 formed between the lower portion 160 of the housing and the base 170. The tray is configured to hold a disposable adhesive pad 182 for capturing insects that exit a bottom of the funnel 185. The device 100 may have a control panel 190 with an ambient light sensor 196, a display 195 to provide status information, and a plurality of actuators 191-194 to allow a user to select one or more programs and adjust settings relating to light brightness and/or fan speed.

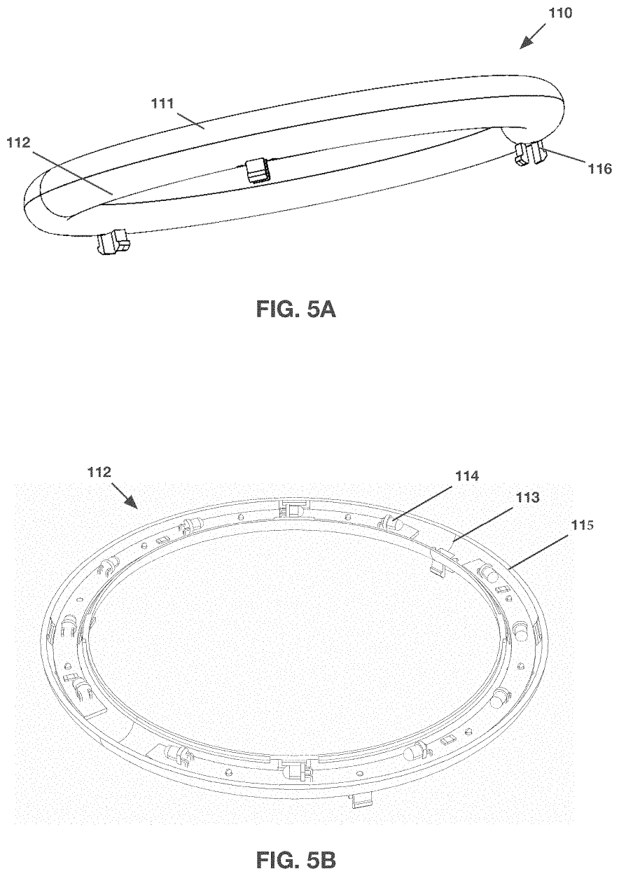

FIG. 5A shows a light assembly 110 having a top portion 111 and a bottom portion 112. FIG. 5A and FIG. 5B show the light assembly 110 in more detail. In FIG. 5B, the top portion 111 has been removed from the bottom portion 112 to expose an internal compartment 113 containing a plurality of LEDs 114.

In one embodiment, the light assembly 110 is positioned above the housing 105. The light assembly 110 may be a light-ring. As shown, the light assembly 110 may have a toroidal-shaped enclosure 115. The enclosure 115 allows for 360-degrees of output of UV light in all directions (e.g., up, inward, outward, and downward). Such configuration may also allow for approaching insects to be pulled into the housing cover 130, via airflow created by the fan 140, regardless of the insect's direction of approach. In one embodiment, the light assembly 110 is shaped and positioned as to prevent insects from being able to land on or otherwise grasp the enclosure 115 while avoiding the downward force of the fan.

In one embodiment, the top portion 111 is attached to the bottom portion 112 to define an internal compartment 113 of the light assembly 110. The assembly 110 may include any number of LEDs 114 disposed within the internal compartment 113. In one embodiment, the light assembly 110 has a plurality of ultra-violet light emitting diodes (UV LEDs) 114. The LEDs are configured to output light within the UV-A wavelength range such a 395 nm or 365 nm or suitable UV wavelength range.

The bottom portion 112 of the light assembly 110 may be attached to the housing 105. For example, the bottom portion 112 may have attachment features 116 to mate with corresponding attachment features on light supports 136 extending from the housing cover 130. As illustrated, the attachment features 116 are deflectable tabs that protrude from the toroidal-shaped enclosure 115 and engage corresponding attachment features with a snap fit.

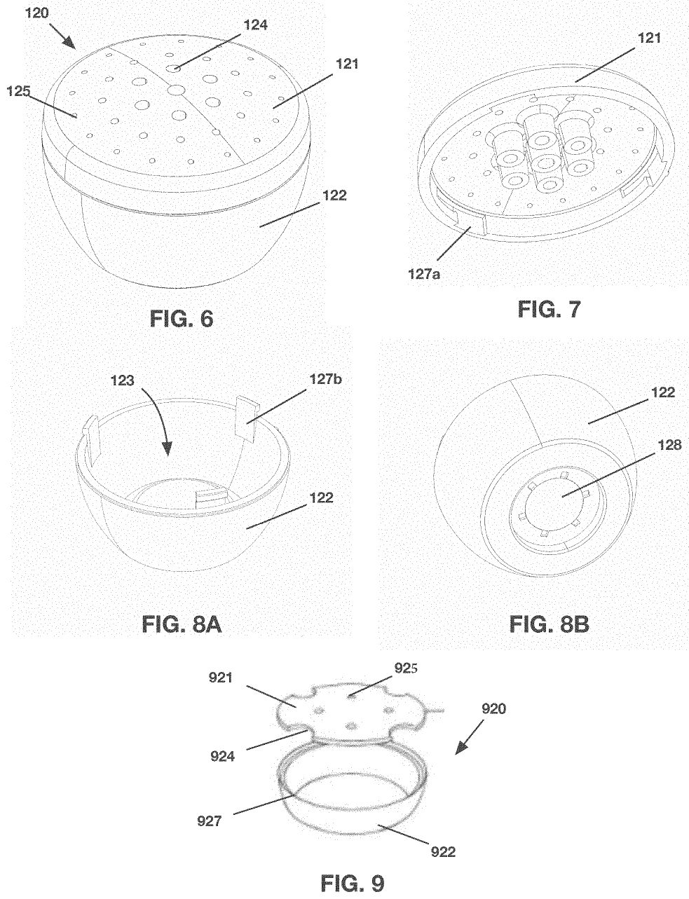

FIGS. 6-9 illustrate the bait portion in more detail. FIGS. 6-7 illustrate one embodiment of a bait container 120 that may be removably secured to an insect capture device. The insect capture device 100 may have a bait container 130 adapted to attract and capture flying insects, such as fruit flies, within an interior thereof. The bait container 130 may be filled with bait, such as vinegar or similar attractant, to lure insects to the device.

The bait container 120 has an interior compartment 123. Larger apertures 124 are formed in the top portion 121 of the bait container 120 through which insects may access interior compartment 123. The larger apertures 124 may be formed in the center of the top portion 121. Smaller apertures 125 are formed in the top portion 121 and are sized to allow bait scent to disperse while preventing insects to escape. Attachment tabs 127a, 127b extend from the top portion 121 to container bottom portion 122 respectively for removably attaching container with an interference fit, for example. Attachment feature 128 may removably attach the container bottom portion 122 to housing cover 130 (e.g., via attachment features 138).

FIGS. 8A-8B illustrate the bottom portion 122 of the bait container 130. In one embodiment, the bait container 130 may be removably attached to, or seated on, the housing cover such that it may be easily cleaned and/or refilled. For example, a bottom surface of the bait container 120 may be removably secured to a top surface of a central portion 134 of the housing cover 130. In one embodiment, the bait container 120 may be positioned such that it sits in the center of the toroidal UV light assembly 110.

In another embodiment, a bottom portion 122 of the container may have a UV-reflective material, such as a plastic or the like. Corresponding magnets may also be used to secure the container 120 to the cover 130. Other features may be used to secure the container to the cover.

FIG. 9 shows a bait container 920 according to another embodiment. The bait container has a top portion 921 and a bottom portion 922. Large apertures 924 are formed along the perimeter of top portion 921. Smaller apertures 925 are formed in the top portion 921. A rim 927 on the bottom portion 922 receives the top portion 921.

As shown in the drawings, the insect control device 100 has a housing 105 that may have a substantially hollow cylindrical shape defining an interior space. In one embodiment, the housing 105 has an upper portion 150 attached to a lower portion 160. A housing cover 130 may be secured to a top of the upper portion 150. And a base 170 may be attached to a bottom of the lower portion 160. The cylindrical housing 105 may be substantially hollow, extending vertically from a closed base 170 to a partially open cover 130.

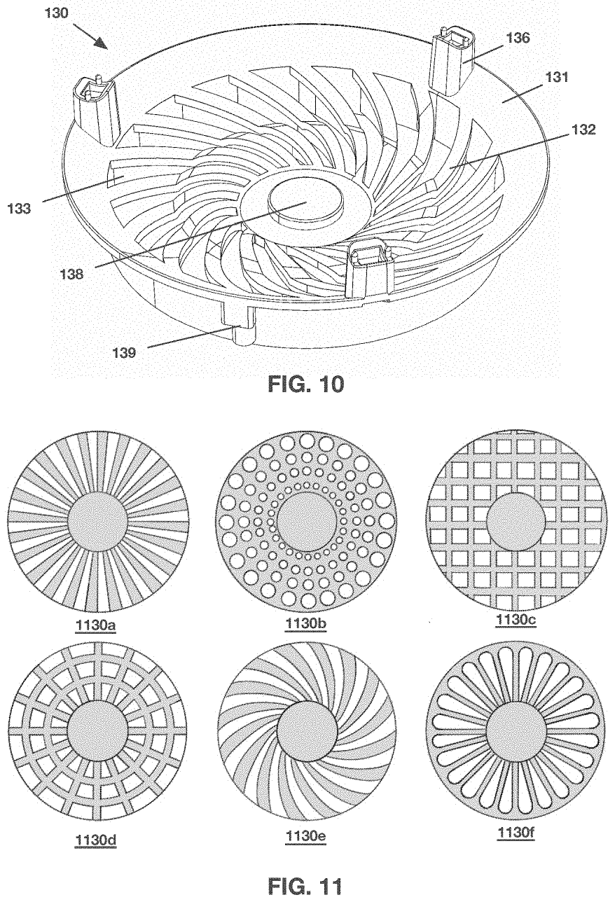

FIG. 10 illustrates a housing cover 130 having a plurality of openings 133 extending through a top surface 132, from a central portion 134 to a rim 131.

The housing cover 130 may have one or more light supports 136 adapted to support the light assembly 110 in a position above the top of the housing 105. As shown, the light supports 136 may extend vertically from a rim 131 of the housing cover 130. The housing cover 130 may also have bait container attachment features 138 for removably attaching the container bottom portion 122 to the central portion 134 of the housing cover 130.

The housing cover 130 may have a plurality of openings 133 in a top surface 132 through which insects may be pulled into an interior space of the housing 105. Generally, the openings 132 may be sized and positioned as to allow substantial airflow therethrough. The openings may also be configured to draw UV light from the light assembly 110.

FIG. 11 shows alternative housing cover embodiments 1130a-1130f, wherein each includes a plurality of openings extending through a top surface thereof.

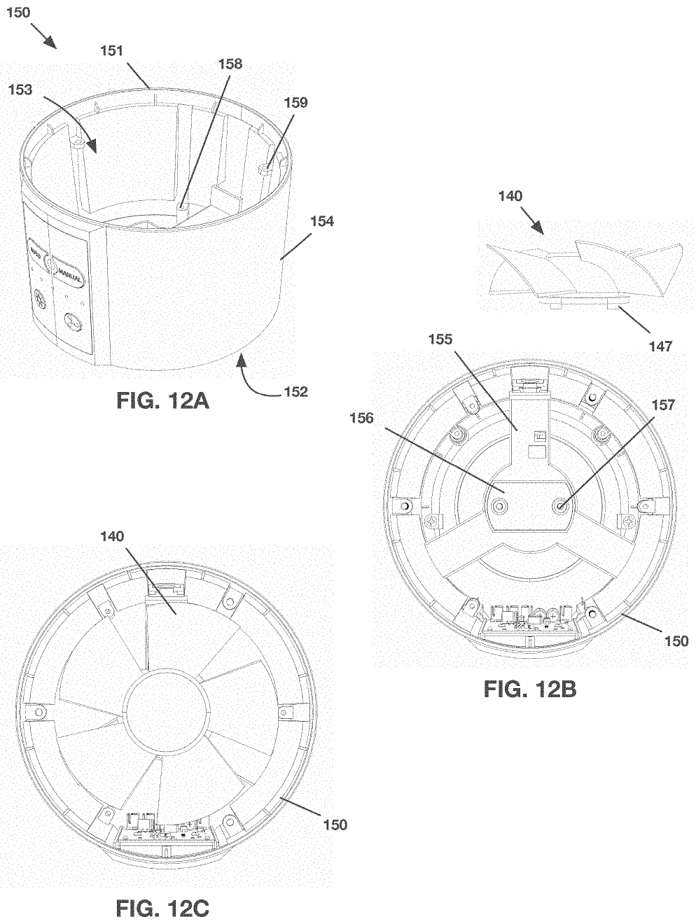

The insect capture device has a fan 140 rotatably mounted within an interior space 153 of an upper portion 150 of the housing 105. Generally, the fan 140 is adapted to create a downward airflow to pull insects through the cover 130 and into the interior space of the housing. FIGS. 12A-12B illustrate the upper portion 150 of a housing 105 and fan 140. FIG. 12B illustrates a top view of the housing upper portion 150 and a fan 140, separately, that may be disposed within an interior space 153 of the upper portion. Housing cover attachment features 159 attach the housing cover 130 to upper portion 150 (e.g., via attachment features 139).

FIG. 12C shows a top view of the housing upper portion 150. The fan 140 is rotatably attached to a fan support structure 155 within the interior space of the upper portion. The fan is supported by rotating portion 156 of fan support. As shown, a fan attachment feature 157 attaches the fan 140 to rotating portion 156 of fan support structure 155 (e.g., via fan attachment features 147). A housing attachment feature 158 attaches the upper portion 150 to the lower portion 160 of the housing (e.g., via corresponding housing attachment features 168). The fan attachment feature 147 attaches the fan, via corresponding attachment features 157, to the rotating portion 156 of fan support structure 155.

In one embodiment, a 5 V fan with pulse width modulation (PWM) control for variable speeds may be employed.

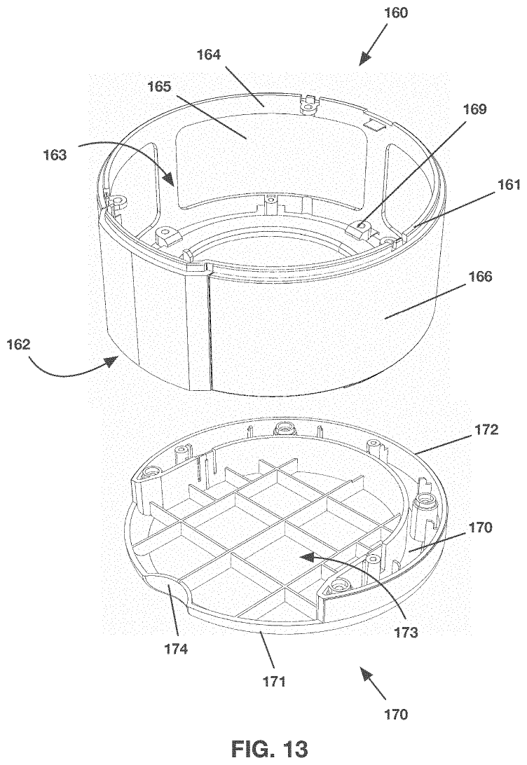

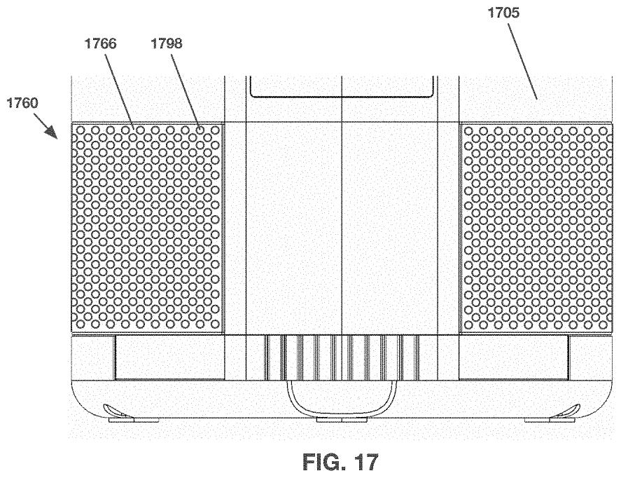

FIG. 13 illustrates a lower portion 160 and a base 170 of a housing according to one embodiment. The base has a closed bottom surface 171 and a raised rear wall 172. An interior compartment 173 of the base 170 is sized to receive the tray 175. A groove in the front surface of the base 170 allows a user to manipulate the tray 175. The lower portion 160 has an inner wall 164 with large apertures to allow air to exit the housing. An outer wall 166 surrounds the inner wall 164. For example, the outer wall 166 may have a grill 1766 including apertures 1798 as shown in FIG. 17. Housing attachment features 169 attach the lower portion 160 to the rear wall 172 of base 170.

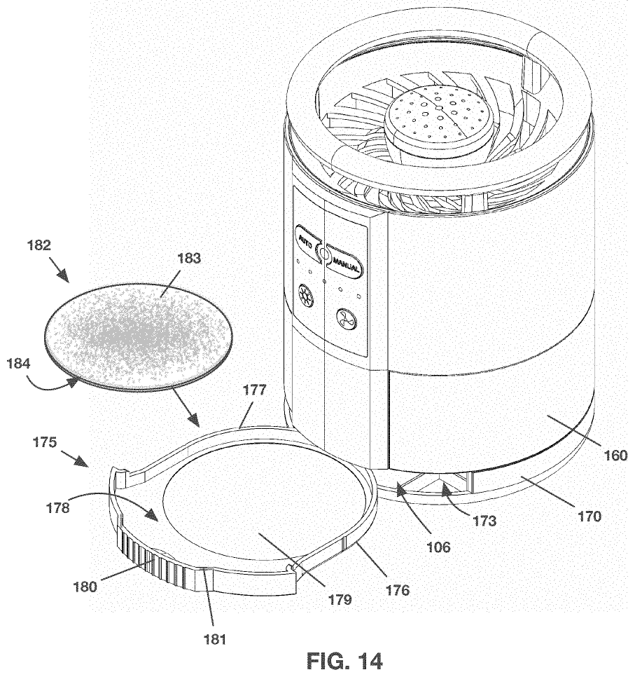

FIG. 14 shows a housing lower portion 160 connected to a housing base 170 to form a slot 106 into which a tray 175 may be removably inserted. The removable tray 175 holds the disposable adhesive pad 182 for capturing insects that exit a bottom of the funnel. The adhesive pad has an adhesive top surface 183 and a non-adhesive bottom surface 184.

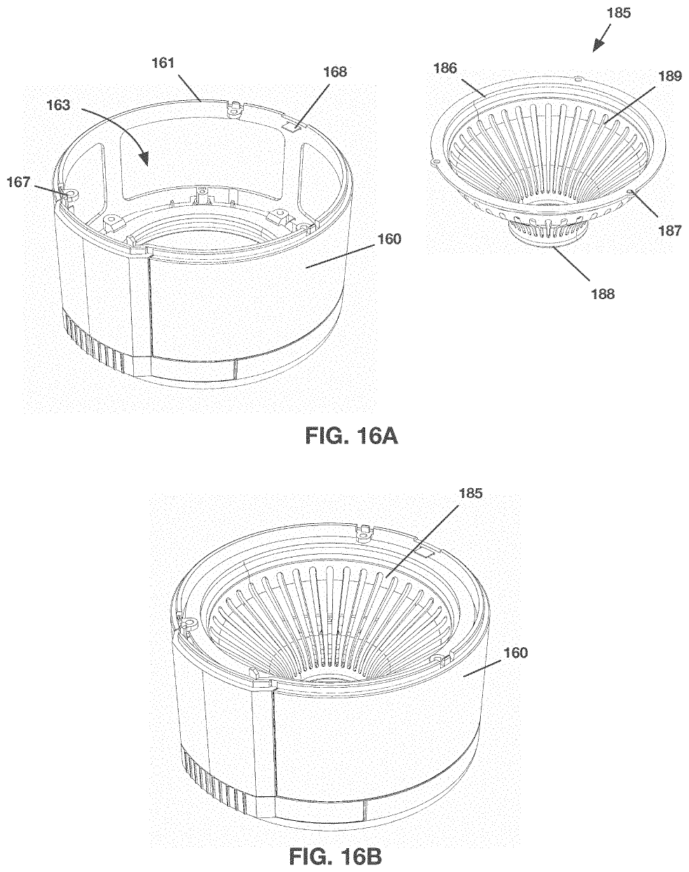

FIG. 16A shows a housing lower portion 160 and a funnel 185 that may be disposed within an interior space 163 of the lower portion.

FIG. 16B shows a funnel 185 seated within an interior space 163 of a housing lower portion 160.

FIGS. 16A-16B illustrate a funnel 185 in more detail. The funnel 185 may be disposed within an interior space 163 of a lower portion 160 of the housing 105. The funnel 185 may sit below the fan 140 such that it directs insects towards an adhesive pad 182. Funnel attachment features 187 attach the funnel 185 within the interior space 163 of housing lower portion 160 (e.g., via corresponding attachment features 167). The funnel 185 has funnel attachment features 187 for attaching the funnel 185 within the interior space 163 of housing lower portion 160 (e.g., via attachment features 167).

In one embodiment, the bottom 188 of the funnel 185 is sized and positioned such that it is directly above the adhesive pad 182 seated in the removable tray 175. Accordingly, airflow through the funnel 185 will direct insects onto the adhesive pad 182. The funnel 185 has a smaller bottom opening 188 that has a circumference substantially equal to that of the adhesive pad 182. The funnel 185 has an open top 186 larger than the small bottom opening 188.

In one embodiment, the funnel 185 has a plurality of slits 189. Such slits may allow air, but not insects, to exit through the side wall of the funnel 185 such that airflow through the bottom 188 of the funnel is reduced. Accordingly, insects may be directed downwards towards the adhesive pad 182 with appropriate force to allow adhesion to the pad.

In one embodiment, the insect capture device has a removable tray 175. The tray 175 may be seated within a slot 106 formed between the lower portion 160 of the housing and the base 170. Generally, the tray 175 is configured to hold a disposable adhesive pad 182 for capturing insects sucked through the bottom of the funnel 185.

The tray 175 may have a closed bottom 176 and a perimeter wall 177 defining an interior compartment 178. In one embodiment, the bottom 176 may have a recessed area 179 configured to hold an adhesive pad 182 therein.

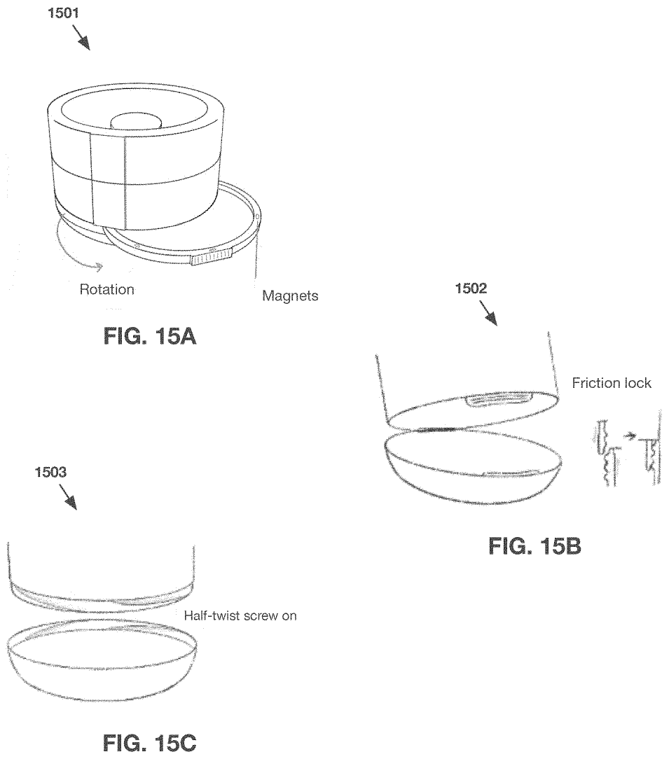

In one embodiment, a front surface of the perimeter wall 177 may have a gripping portion 180 to facilitate removal of the tray 175 from the slot 106. Additionally or alternatively, a front surface of the base 170 may have a groove to allow a user to more easily manipulate the tray 175 into/out of the slot 106. It will be appreciated that the front surface of the perimeter wall 177 is shaped to completely close the slot 106 when the tray is fully inserted into the housing. Tray attachment features 181 may also be provided for removably securing the tray 175 within slot 106, such as magnets or the like or as illustrated in FIGS. 15A-15C.

FIGS. 15A-15C illustrate alternate embodiments of the housing lower portion and housing base. For example, FIG. 15A shows a rotatable tray 1501 with magnets to removably secure the tray 175 within the slot 106 of the housing 105. FIG. 15B shows a friction lock mechanism 1502 for removably securing the lower portion 160 of the housing 105 to the base 170. FIG. 15C shows a half-twist screw-on mechanism 1503 for removably securing lower portion 160 of the housing 105 to the base 170.

FIG. 17 illustrates a housing lower portion 1760 having a plurality of apertures 1798 extending through an outer surface 1766 thereof. The apertures 1798 extend from the outer surface to the interior space of the lower portion 1766 to allow air to exit the housing.

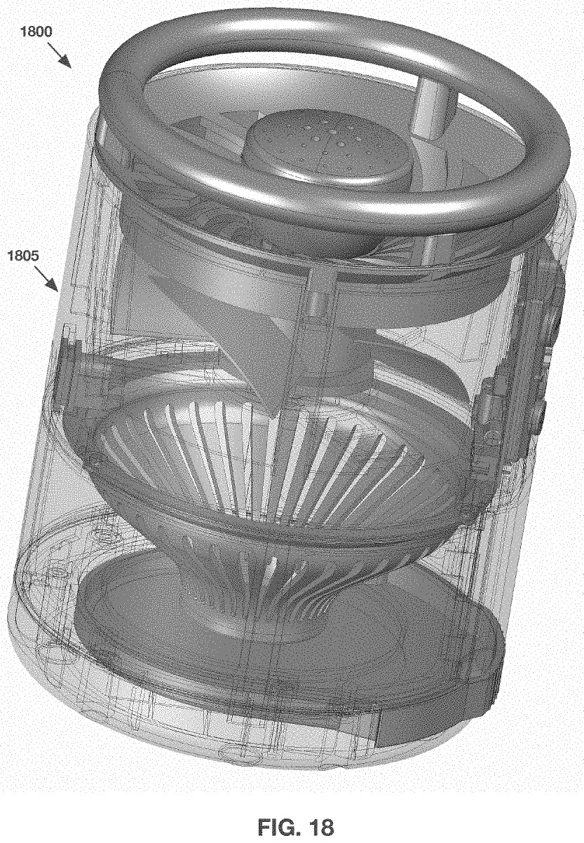

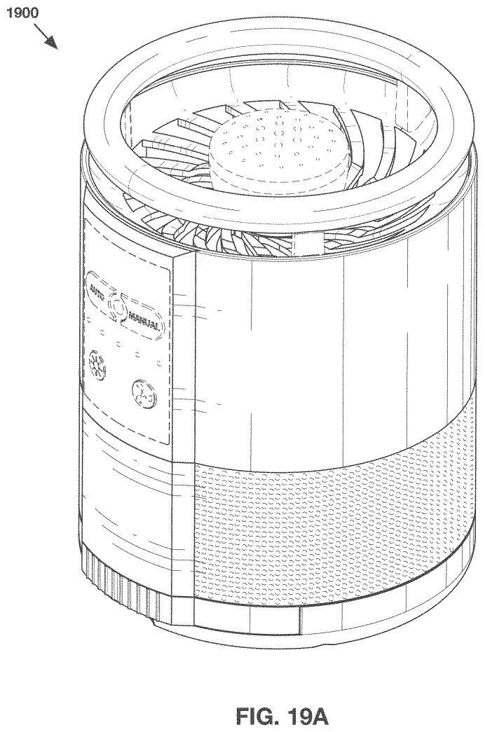

FIG. 18 illustrates an insect control device 1800, wherein the housing 1805 is transparent.

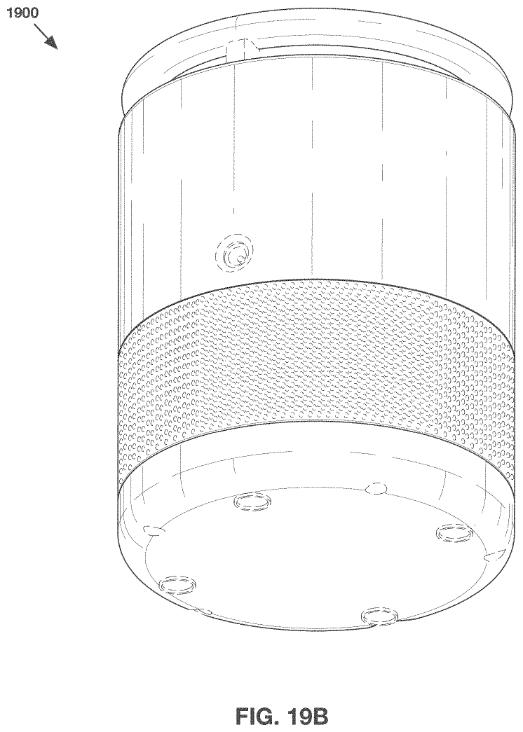

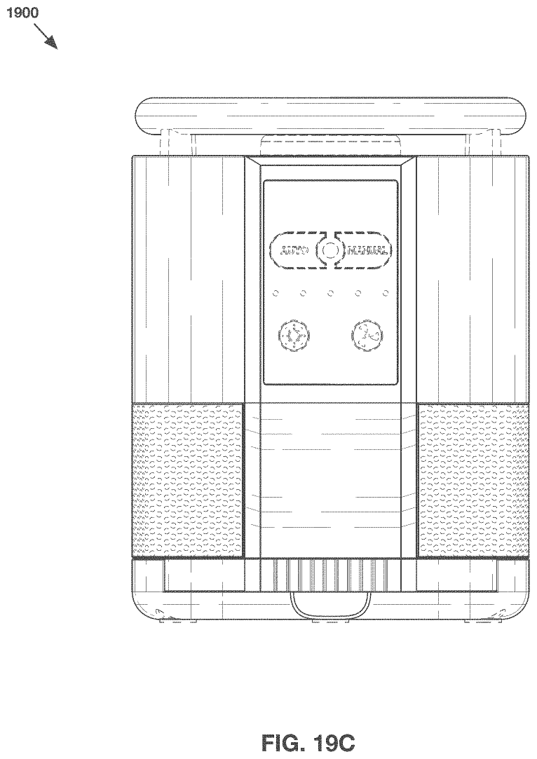

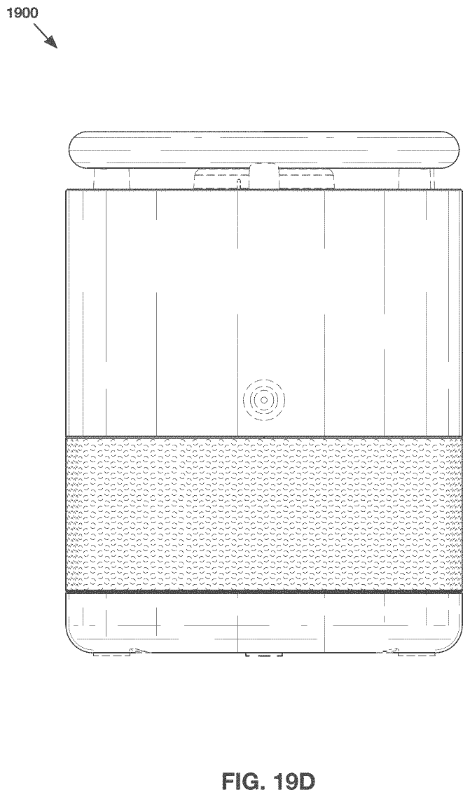

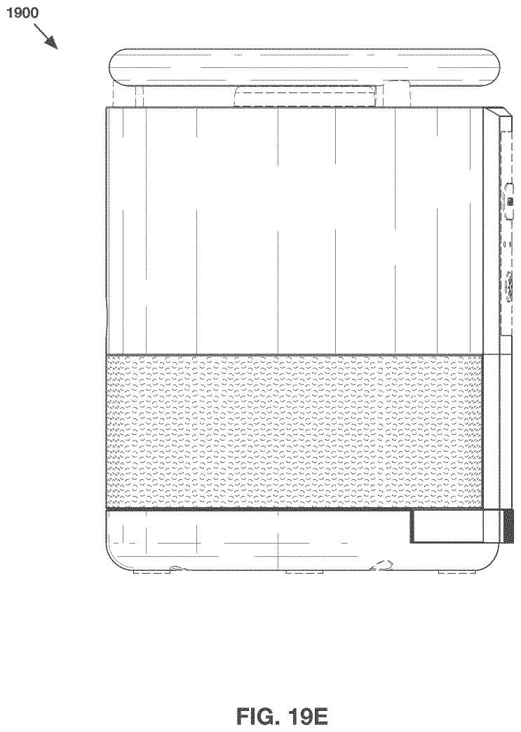

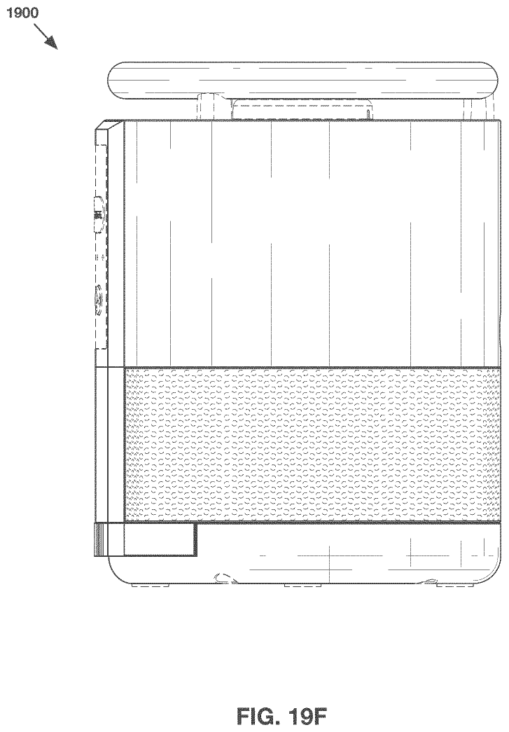

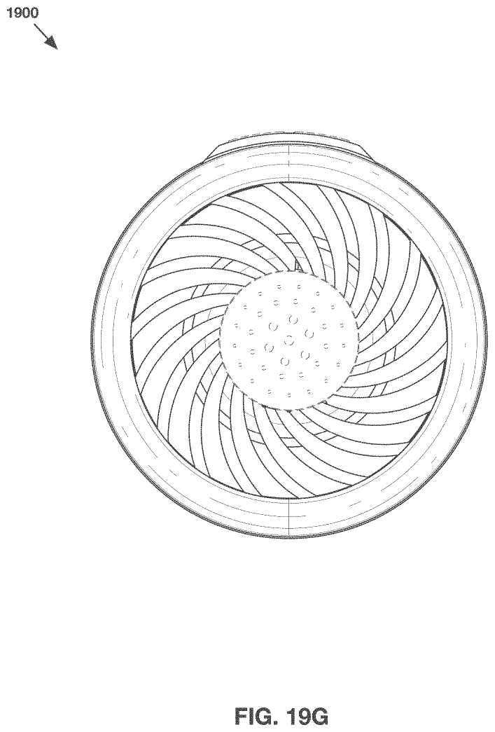

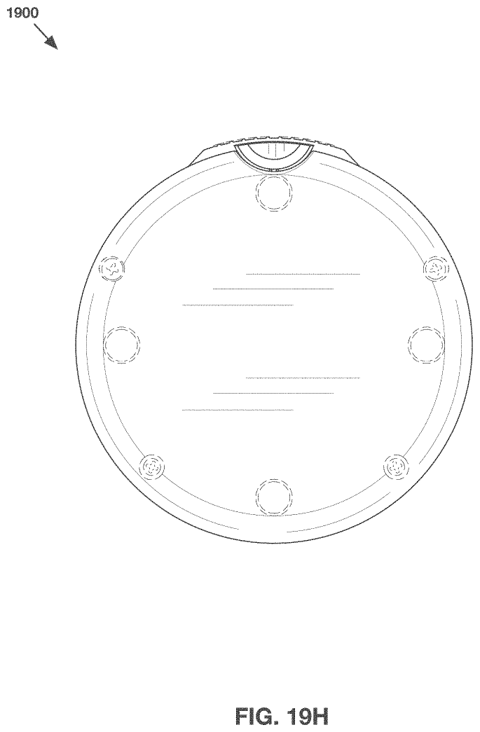

FIGS. 19A-19H show various views of another exemplary insect control device 1900 according to an embodiment.

The insect capture device 100 may have a control panel 190 in communication with a controller. As shown, the control panel 190 may be seated within a flat portion of the housing 105.

The control panel 190 may have a display 195 that provides information relating to a current status of the device. In one embodiment, the display may have a plurality of indicator lights 196 which are shared by the fan and light buttons to indicate the speed of the fan or the brightness of the light assembly. For example, one lit display light may indicate the device is set to a lowest brightness or lowest fan speed setting (e.g., 20%). As another example, two lit display lights may indicate the device is set to a second lowest brightness or fan speed (e.g., 40%).

In one embodiment the control panel has buttons 191, 192 to switch between an automatic mode and a manual mode. Automatic mode is configured to turn the light assembly and fan on when the light sensor 196 senses low ambient lighting. The manual mode functions as an on/off switch for the light and fan.

In one embodiment, the automatic mode 191 and manual mode 192 buttons may each have an LED indicator. For the manual mode button, the button's LED is lit when the unit is on, and not lit when the unit is off. For the automatic mode button, the button's LED is lit when auto mode is enabled, and off when it is disabled.

The control panel 190 may further have a light adjustment button 194 and a fan adjustment button 193. If the user clicks the light 194 or fan 193 adjustment button, then the display lights 195 will turn on for 5 seconds showing the current setting. If the user clicks the same button again within the 5 seconds, then the brightness/speed will increase by one step (e.g., 20%). It will be appreciated that clicking the button again will increase the brightness/speed by 20% up to 100%. If the setting is on 100% with all 5 display lights lit, and the button is clicked again, then the brightness/speed will be reduced to 20% and only one of the display lights will remain lit.

In one embodiment, the device 100 may receive power via a power cable connected to a power port 197 located on a rear surface of the housing. For example, the device may receive up to 10 W power (5 V at 2 A), via a USB cable plugged into the power port.

Although not shown, the device 100 may have any number of additional electrical components. Exemplary components include, but are not limited to, one or more controllers, internal or external memory (e.g., for storing various programs and/or user preferences relating to fan speed and/or light intensity), batteries, communication units, electrical circuitry and the like.

The following is a list of reference numbers:
100 insect capture device
105 substantially hollow cylindrical housing
106 slot in housing
110 light assembly
111 light assembly top portion
112 light assembly bottom portion
113 interior compartment of light assembly
114 UV LEDs
115 Toroidal enclosure
116 light attachment features
120 bait container
121 bait container top portion
122 bait container bottom portion
123 interior compartment of bait container
124 larger apertures in top portion of bait container
125 smaller apertures in top portion of bait container
127a,b attachment tabs
128 Attachment feature
130 housing cover
131 rim of housing cover
132 top surface of housing cover
133 openings in top surface
134 central portion of housing cover
136 light supports
138 bait container attachment feature
139 housing cover attachment features
140 fan
141 fan blades adapted to direct air downwards when fan rotates
142 central portion of fan
147 fan attachment features
150 housing upper portion
151 open top surface of housing upper portion
152 open bottom surface of upper portion
153 interior compartment of housing upper portion
154 outer wall of upper portion
155 fan support structure in interior compartment
156 rotating portion of fan support
157 fan attachment feature
158 housing attachment feature
159 housing cover attachment features
160 housing lower portion
161 open top surface of lower portion
162 open bottom surface of lower portion
163 interior compartment of lower portion
164 inner wall of lower portion
165 large apertures in inner wall
166 outer wall surrounding inner wall
167 funnel attachment features
168 corresponding housing attachment feature
169 housing lower portion/base attachment features
170 base
171 closed bottom surface of base
172 raised rear wall of base
173 interior compartment of base
174 groove in front surface of base
175 removable tray
176 closed bottom of tray
177 perimeter wall of tray
178 interior compartment of tray
179 Recessed area
180 gripping portion on front surface of perimeter wall
181 tray attachment features
182 adhesive pad for capturing insects
183 adhesive top surface of adhesive pad
184 non-adhesive bottom surface of adhesive pad
185 funnel for directing insects to adhesive pad
186 larger inlet opening of funnel
187 funnel attachment features
188 smaller bottom outlet opening
189 slits in funnel
190 control panel
191 automatic mode actuator
192 manual mode actuator
193 fan speed actuator
194 light intensity actuator
195 display comprising a plurality of LED lights to provide status information
196 ambient light sensor
197 power port for receiving power cable
920 alternative embodiment of bait container
921 top portion of bait container
922 container bottom portion of bait container
924 large apertures along perimeter of top portion
925 smaller apertures in top portion
927 rim for receiving top portion
1130a-f alternative housing cover embodiments
1501 rotatable tray with magnets
1502 friction lock mechanism
1503 half-twist screw on mechanism
1705 housing
1760 lower portion of housing
1766 grill defining outer surface of lower portion
1798 apertures
1800 exemplary insect capture device
1900 exemplary insect capture device

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An insect capture device comprising:
a housing having a cover with a plurality of openings through which insects enter the housing;
a light assembly mounted to the housing and adapted to attract the insects;
a bait container mounted on the housing to hold insect bait;
a fan disposed within the housing oriented to pull insects through the cover and into the housing; and
a removable tray cooperating with the housing, the tray configured to hold an adhesive pad for capturing insects that entered the housing.

2. The insect capture device of claim 1, wherein the light assembly comprises a plurality of ultraviolet light-emitting diodes (UV LEDs).

3. The insect capture device of claim 1, wherein the light assembly extends above the housing.

4. The insect capture device of claim 1, wherein the light assembly is spaced apart above the housing.

5. The insect capture device of claim 1, wherein the light assembly has a toroidal-shaped enclosure.

6. The insect capture device of claim 1, further comprising a funnel disposed within the housing to direct the insects toward the adhesive pad.

7. The insect capture device of claim 6, wherein the funnel is disposed below the fan, the funnel having an inlet opening adjacent the fan, and an outlet opening adjacent the adhesive pad, wherein the outlet opening is smaller than the inlet opening.

8. The insect capture device of claim 1, further comprising a controller and in communication with the fan and the light assembly, the controller programmed to:
provide a signal to the fan and light assembly to vary at least one of a brightness of the light assembly or a speed of the fan.

9. The insect capture device of claim 8, further comprising an ambient light sensor in communication with the controller, the controller programmed to:
receive an ambient light input from the ambient light sensor;
provide a signal to automatically vary at least one of the brightness of the light assembly or the speed of the fan based on the ambient light input.

10. The insect capture device of claim 9, wherein the controller is programed to:
if the ambient light input decreases, automatically increase at least one of the brightness of the light assembly or the speed of the fan.

11. The insect capture device of claim 8, further comprising a control panel in communication with the controller, the controller programmed to:
receive an input from a user;
provide a signal to vary at least one of the brightness of the light assembly or the speed of the fan based on the input of the user.

12. The insect capture device of claim 1, wherein the tray is seated within a slot formed in a lower portion of the housing.

13. The insect capture device of claim 1, wherein the tray has a recessed area to hold the adhesive pad.

14. The insect capture device of claim 1, wherein the bait container is mounted to the cover outside the housing and has a plurality of apertures formed in a top portion.

15. An insect capture device comprising:
a cylindrical housing having a cover with a plurality of openings through which insects enter the housing;
a light ring assembly having at least one ultra-violet LED (UV LED) adapted to attract insects, the light ring mounted to the housing at a spaced apart location from the cover;
a bait container mounted to the cover outside the housing to hold insect bait;
a fan disposed within the housing oriented to pull insects through the cover and into the housing;
a removable tray cooperating with the housing, the tray configured to hold an adhesive pad for capturing insects that entered the housing; and
a conical funnel positioned between the fan and the tray to direct the insect towards the adhesive pad.

16. The insect capture device of claim 15, wherein the light ring assembly has a toroidal-shaped enclosure.

17. The insect capture device of claim 16, wherein the funnel has an inlet opening adjacent the fan, and an outlet opening adjacent the adhesive pad, wherein the outlet opening is smaller than the inlet opening.

18. An insect capture device comprising:
a housing having a cover with a plurality of openings through which insects enter the housing;
a light assembly mounted to the housing and adapted to attract the insects;
a fan disposed within the housing oriented to pull insects through the cover and into the housing;
a bait container mounted on the housing to hold insect bait;
a removable tray cooperating with the housing configured to hold a replaceable adhesive pad for capturing insects that entered the housing; and
a controller in communication with the fan and the light assembly, the controller programmed to:
provide a signal to the fan and light assembly to vary at least one of a brightness of the light assembly or a speed of the fan.

19. The insect capture device of claim 18, further comprising an ambient light sensor in communication with the controller, the controller programmed to:
receive an ambient light input from the ambient light sensor;
provide a signal to automatically vary at least one of the brightness of the light assembly or the speed of the fan based on the ambient light input.

20. The insect capture device of claim 18, further comprising a control panel in communication with the controller, the controller programmed to:
receive an input from a user;
provide a signal to vary at least one of the brightness of the light assembly or the speed of the fan based on the input of the user.
